(19) United States
(12) Patent Application Publication
(10) Pub. No.: US 2007/0226674 A1
(43) Pub. Date: Sep. 27, 2007

(54) System and method for semiconductor device fabrication using modeling

(76) Inventors: Henning Haffner, Pawling, NY (US); Lars W. Liebmann, Poughquag, NY (US); Donald Samuels, Silverthorne, CO (US); Steven Scheer, Austin, TX (US)

Correspondence Address: SLATER & MATSIL LLP, 17950 PRESTON ROAD, SUITE 1000, DALLAS, TX, 75252, US

(21) Appl. No.: 11/390,982

(22) Filed: Mar. 27, 2006

(51) Int. Cl. G06F 17/50

(52) U.S. Cl. 716/19

(57) ABSTRACT

System and Method for Semiconductor Device Fabrication Using Modeling System and method for using adjustment patterns as well as physical parameters as targets to control mask structure dimensions using optical proximity correction. A preferred embodiment includes defining targets based on definition rules and adjusting mask layer structures based on the targets. The targets comprise structures that are visible in the reproduced pattern as well as targets that affect geometric properties. The targets that affect geometric properties include target sacrificial structures that are selected from one or more of the following groups: actual sacrificial structures that are visible only in an intermediate exposure of the reproduced pattern, virtual sacrificial structures of a mask layer having at least one dimension smaller than a minimum dimension required for resolution, and virtual sacrificial structures not part of the reproduced pattern. Furthermore, targets that affect physical properties, such as light intensity, can be defined and utilized in the adjusting.

### TECHNICAL FIELD

The present invention relates generally to a system and a method for semiconductor device fabrication, and more particularly to a system and a method for using adjustment patterns as well as physical parameters as targets to control mask structure dimensions using optical proximity correction.

### BACKGROUND

The accurate reproduction of patterns on the surface of a semiconductor substrate is critical to the proper fabrication of semiconductor devices. The semiconductor substrate may have undergone previous fabrication processes and may already feature layers and structures created by those fabrication processes. Improperly reproduced patterns can result in semiconductor devices that do not operate to design specifications or do not operate at all. For example, transistors can be created with improperly sized gates, conductors can be created that are short circuited or open circuited with other conductors or devices, structures can be created with wrong geometries, and so forth. Improperly reproduced patterns can reduce the yield of the fabrication process, thereby increasing the overall cost of the product. The reproduction process typically involves the use of optical lithography to reproduce the patterns onto the surface of the semiconductor substrate that is subsequently followed with a variety of processes to either subtract (for example, etch) and add (for example, deposit) materials from and to the semiconductor substrate.

However, as the dimensions of the structures making up the patterns continue to become smaller, their sizes approach (in some cases, the dimensions of the structures are smaller than) the wavelength of the light used in optical lithography, the interference and processing effects can cause distortions and deviations in the patterns as they are reproduced onto the semiconductor substrate. In addition to the relationship between structures of the patterns and the wavelengths of the light, other factors that can cause distortion include the numerical aperture of the imaging system and the minimum pitch between structures in the pattern. The result being a reproduced pattern having a dramatically different appearance from the pattern being reproduced, also known as the intended pattern. The distortions and deviations in the reproduced pattern are dependent upon the characteristics of the pattern, such as the shape and size of the structures in the pattern, the presence of neighboring patterns and structures around the pattern, as well as the process conditions. For example, the interactions of the light with the structures making up a pattern can result in the reproduced pattern having rounded corners, bulges towards another elements, and so forth.

With reference now to FIGS. 1a and 1b, there are shown diagrams illustrating an exemplary pattern used in semiconductor device fabrication and a simulated reproduced pattern on a semiconductor substrate. The diagram shown in FIG. 1a illustrates a pattern 100 that is to be reproduced on a semiconductor wafer. The pattern 100 includes a plurality of structures, such as structure 105, structure 106, structure 107, structure 108, and structure 109. Ideally, there will be a one-to-one correspondence between the pattern 100 and the reproduced pattern on the semiconductor substrate.

The diagram shown in FIG. 1b illustrates a simulation of the pattern 100 as it is reproduced onto the semiconductor substrate. For example, if a threshold photoresist model is used and the dose is set to a value of 3.3 times the dose-to-clear (i.e., the dose required to develop the resist in a large clear area), then intensities of greater than or equal 0.3 will print in the photoresist. These thresholds are shown in FIG. 1b. The diagram illustrates that the more isolated regions of the pattern 100 reproduce smaller, for example, threshold 155 and threshold 156, than the more nested regions, for example, threshold 160 and threshold 161.

Optical proximity correction (OPC) is a prior art technique wherein fragments of the structures making up the pattern can be modified (moved) so that associated mask patterns no longer look like the intended pattern, but through the previously discussed interactions between the light and the structures, the reproduced pattern on the semiconductor substrate made using the modified mask patterns will have an appearance that is closer to the intended pattern in appearance than the reproduced pattern made using the unmodified patterns. OPC is normally performed using computer-aided design (CAD) tools and involves the partitioning of edges of structures of a pattern into multiple fragments, which can be moved around to yield the desired reproduced pattern. The movement of the fragments can occur over multiple iterations to reach the desired reproduced pattern.

With reference now to FIG. 2, there is shown a diagram illustrating a prior art OPC system 200. The diagram shown in FIG. 2 illustrates a model based OPC system. Other types of OPC systems include rules based systems. The model based OPC system 200 includes an OPC engine 205, which is typically a computer application that takes as input one or more layouts 210 of the pattern (the intended pattern) used in the fabrication of the semiconductor device. The OPC engine 205 then simulates the movement of fragments of the various structures of the pattern, which results in changes to associated mask layers, and computes a resulting reproduced pattern on a semiconductor substrate based on the associated mask layers.

The computations of the OPC engine 205 can be repeated until the computed (simulated) reproduced pattern has an appearance sufficiently similar to the intended pattern. The computation of the reproduced pattern by the OPC engine 205 can make use of OPC models 215. The OPC models 215 can contain information specific to the process technology being used in fabrication, exposure specific information, process design rules, and so forth. Multiple models can be used to provide a simulation study of a process window for a range of fabrication conditions, such as variations in materials, temperatures, pressures, focus, and so on. The computation of multiple models to obtain a study of the process window is referred to as process window OPC.

In addition to utilizing the OPC models 215 in the computation of the placement of the fragments, the OPC engine 205 can also make use of restrictions 220. Restrictions can include information such as resolution limits, inspection limits, and so on. Using the OPC models 215 and the restrictions 220, the OPC engine 205 can generate mask layouts 225 for each mask layer of the intended pattern. The OPC engine 205 can utilize techniques such as iterative computation where the OPC engine 205 can move fragments (resulting in a change in the associated mask patterns) and compute its effect on the reproduced pattern, and continue to move the fragments around until a desired result is achieved. Alternatively, the OPC engine 205 can compute backwards from a desired result to determine a proper position for the fragment(s).

One disadvantage of the prior art is that the OPC engine only makes use of actual structures in a reproduced pattern (also referred to as a target layer) in its correction computations. However, in more advanced pattern reproduction techniques, multiple exposures of different patterns can be utilized to yield a better quality reproduced pattern. An exposure of a pattern in the multiple exposure technique may yield structures (referred to herein as sacrificial structures or sacrificial patterns) that are present only after the exposure of that specific pattern and when all exposures of the multiple patterns making up the intended pattern are complete, the sacrificial structures may disappear. The prior art OPC engine does not consider the sacrificial structures in its correction computations. However, the consideration of the sacrificial structures in the correction computations may lead to a better result. The prior art OPC engine is, in effect, ignoring additional information that it can be using to improve the quality of the reproduced pattern.

Yet another disadvantage of the prior art is that in order to develop a good simulation of the manufacturing process (process window OPC), the prior art OPC technique requires the use of a number (a potentially large number) of different models, with the OPC computation process being repeated for each of the models. Therefore, a large amount of computer time needs to be spent, as well as the proper development of the models to ensure that they encompass all of the desired process window parameters.

### SUMMARY OF THE INVENTION

These and other problems are generally solved or circumvented, and technical advantages are generally achieved, by preferred embodiments of the present invention which provides a system and a method for using adjustment patterns as well as physical parameters as targets to control mask structure dimensions using optical proximity correction.

In accordance with a preferred embodiment of the present invention, a method for controlling lithographic mask layer structure dimensions for use in reproducing a pattern is provided. The method includes defining targets based on definition rules and adjusting mask layer structures based on the targets. The targets include targets that are visible in a reproduced pattern and targets that affect geometric properties.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of an exemplary pattern and a simulated pattern reproduced on a semiconductor substrate;

FIG. 2 is a diagram of a prior art OPC system;

FIGS. 3a through 3d are diagrams of a composite pattern and various layers decomposed from the composite pattern;

FIGS. 4a through 4f are diagrams of a composite pattern and various layers decomposed from the composite pattern with sacrificial patterns, according to a preferred embodiment of the present invention;

FIG. 5 is a diagram of an OPC system, according to a preferred embodiment of the present invention;

FIG. 6 is a diagram of a sequence of events in the correction of layer patterns, according to a preferred embodiment of the present invention;

FIGS. 7a through 7k are diagrams of algorithmic representations of implementations of OPC engines, according to a preferred embodiment of the present invention;

FIG. 8 is a diagram of mask structures in a photomask and their effect on light passing through the photomask, according to a preferred embodiment of the present invention;

FIG. 9 is a diagram an algorithm representation of an implementation of an OPC engine, wherein energy levels are used to provide information usable in correction computations, according to a preferred embodiment of the present invention; and

FIG. 10 is a diagram of a sequence of events in the manufacture of a semiconductor device, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a design system utilizing OPC that uses actual and virtual sacrificial patterns as well as physical parameters as targets to control mask structure dimensions, wherein optical lithography is used in the reproduction of patterns. The actual and virtual sacrificial patterns, along with the target patterns, can be collectively referred to as adjustment patterns or adjustment structures. The invention may also be applied, however, to semiconductor fabricating processes with other forms of lithography wherein the wavelength of the electromagnetic waves used to transfer the patterns approaches the dimensions of the patterns. Additionally, the invention can also be applied to semiconductor fabrication processes where an interaction between the wavelength, the numerical aperture of the imaging system and a minimum pitch between structures can cause distortions in the reproduction of mask patterns.

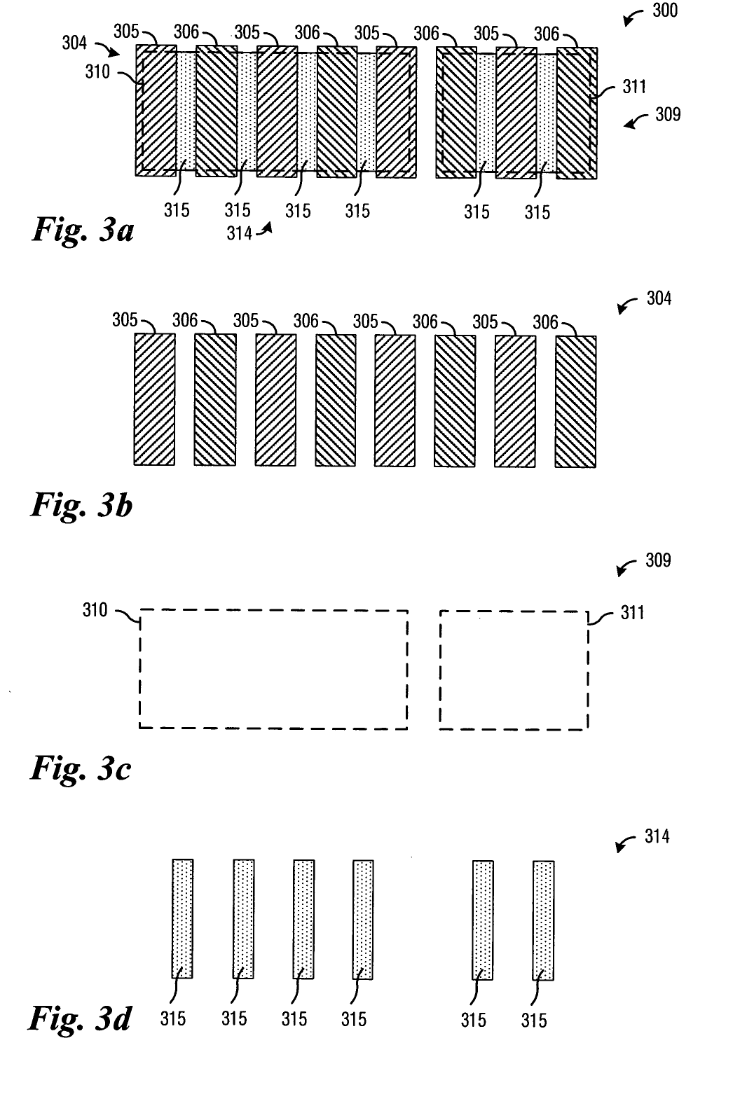

FIGS. 3a through 3d provide diagrams illustrating a composite pattern 300 and various layers decomposed from the composite pattern 300. The composite pattern 300, as shown in FIG. 3a, can be used in a dual-exposure system. Similar patterns exist for multi-exposure systems, wherein the number of exposures is different from two. The composite pattern 300 shown in FIG. 3a can be used to pattern a series of parallel structures on a photoresist layer over a semiconductor substrate.

The composite pattern 300 includes a phase mask layer 304 that includes different structures that alter the phase of light passing through the phase mask. FIG. 3b shows just the phase mask layer 304 of the composite pattern 300. As shown in FIGS. 3a and 3b, the phase mask layer 304 includes two different types of structures 305 and 306, with each structure type altering the phase of light differently. The structure 305 and structure 306 of the phase mask layer 304 (as shown in FIG. 3b) passes light, with the remainder of the phase mask layer 304 blocking light. For example, a first structure type may pass light with phase shift of 0 degrees with respect to a selected phase reference while a second structure type may pass light with phase shift of 180 degrees with respect to the same phase reference. Although shown with two different types of structures, a phase mask layer may have more than two different types of structures.

The composite pattern 300 also includes a block mask layer 309 that can be used to expose or block specific portions of the photoresist layer to or from light. The block mask layer 309, which can also be referred to as a trim mask layer, is shown by itself in FIG. 3c. The block mask layer 309 shown in FIG. 3a includes two structures, structure 310 and structure 311, which block light while the remainder of the block mask layer 309 (as shown in FIG. 3c passes light).

The composite pattern 300 further includes a target layer 314. The target layer 314, which is shown in FIG. 3d, comprises the actual structures that will be created after the exposure of the photoresist layer to light passing through the phase mask layer 304 and the block mask layer 309. The target layer 314 includes structures 315.

A structure in a mask layer can affect the light used in lithographic imaging in one of several ways: the structure can completely block the passage of the light, the structure can completely pass the light, or the structure can partially block the passage of the light. For example, as shown in FIG. 3a, the structures of the block mask layer 309 block the passage of the light and the structures of the phase mask layer 304 pass the light.

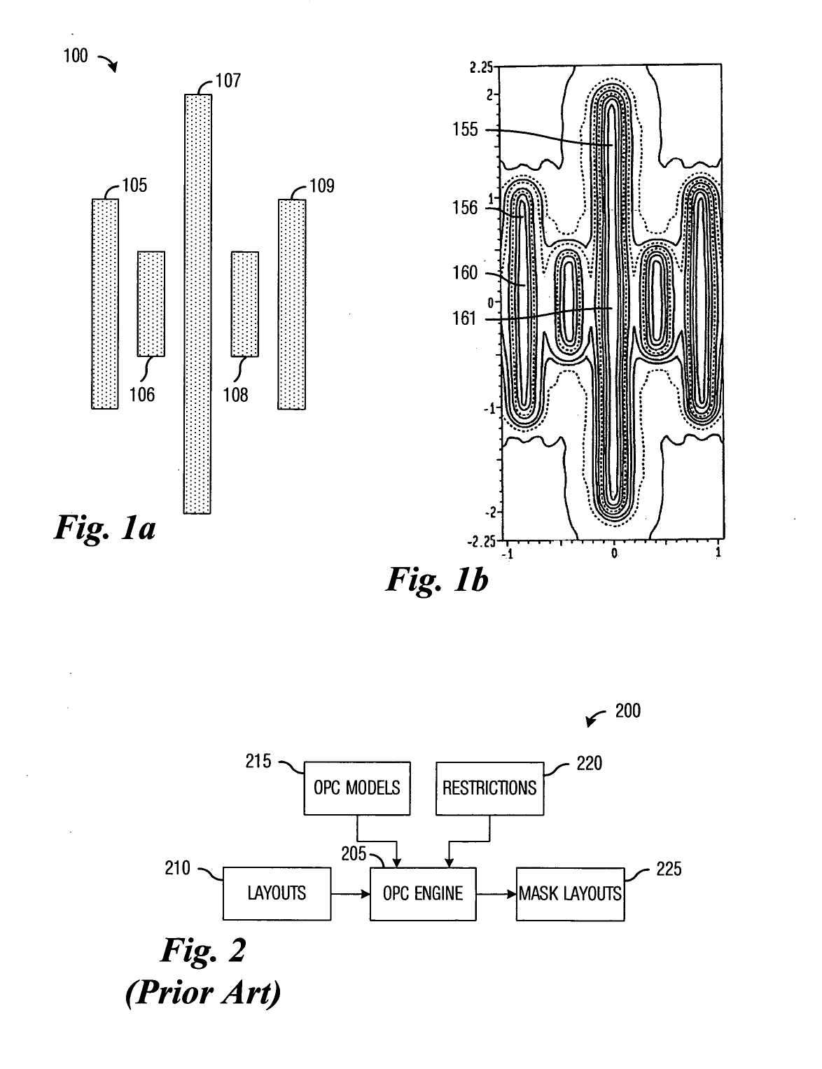

A prior art OPC engine, such as the OPC engine 205 (FIG. 2), would make use of the three layers of the composite pattern 300 in its correction computations. Depending on the implementation of the OPC engine 205, the quality of the OPC model 215, restrictions 220, and so forth, the quality of the resulting mask layouts 225 may vary in terms of matching the reproduced pattern on the semiconductor substrate with an intended pattern provided at an input of the OPC system 200. However, the quality of the match between the reproduced pattern and the intended pattern can be increased by making use of additional information that may be present in the various layers of the composite pattern 300.

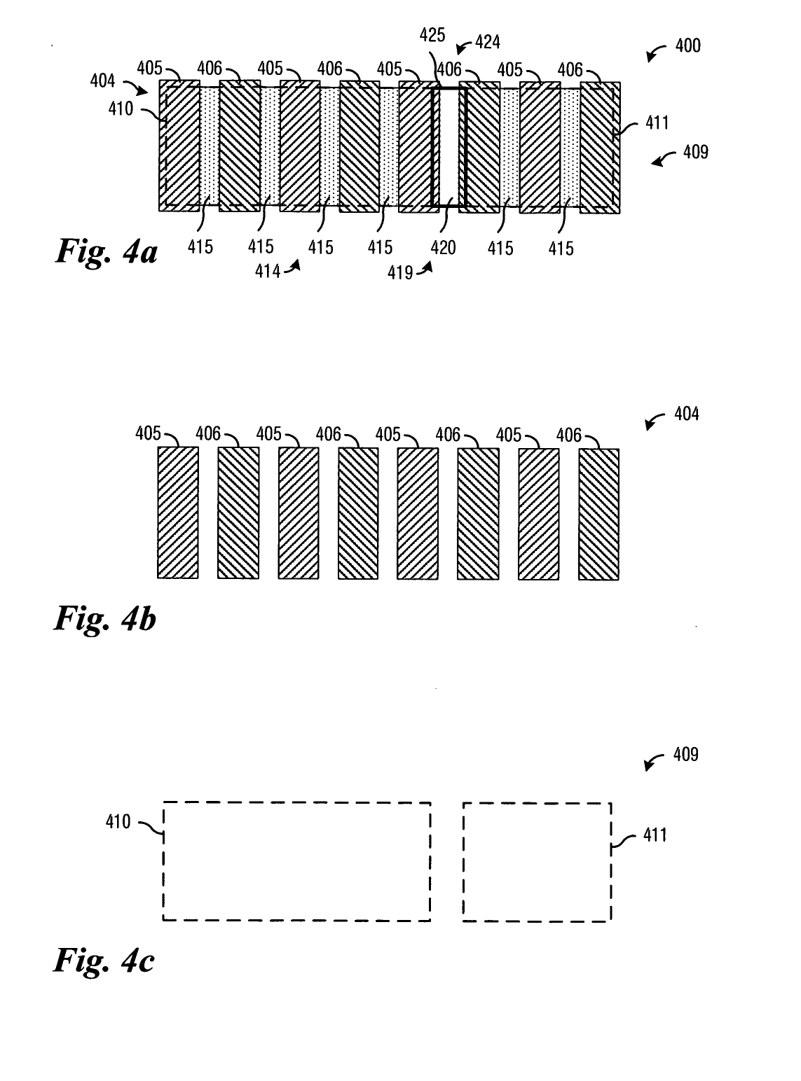

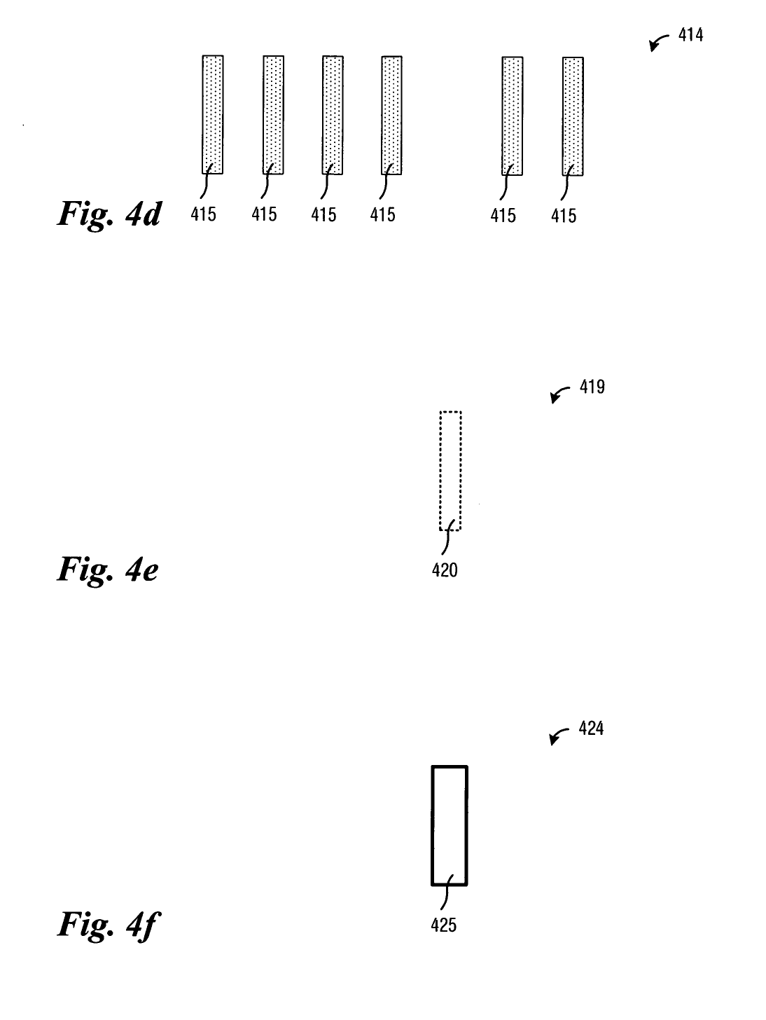

FIGS. 4a through 4f provide diagrams illustrating a composite pattern 400 and various layers decomposed from the composite pattern 400, wherein sacrificial patterns are shown, according to a preferred embodiment of the present invention. Like the composite pattern 300 shown in FIG. 3a, the composite pattern 400 can be used to pattern a series of parallel structures on a photoresist layer of a semiconductor substrate.

The composite pattern 400 includes a phase mask layer 404, as a shown in FIG. 4b. The phase mask layer 404 includes two different types of structures, namely structure 405 and structure 406, with each structure type altering the phase of light differently. The composite pattern 400 also includes a block mask layer 409 that can be used to expose or block specific portions of the photoresist layer to or from light. The block mask layer 409 is shown in FIG. 4c. The block mask layer 409 includes two structures, structure 410 and structure 411. The composite pattern 400 further includes a target layer 414 as shown in FIG. 4d. The target layer 414 comprises the actual structures that will be created after the exposure of the photoresist layer to the phase mask layer 404 and the block mask layer 409. The target layer 414 includes multiple structures 415.

Unlike the composite pattern 300 shown in FIG. 3a, the composite pattern 400 also includes two additional layers. A first layer in the composite pattern 400 that is not included in the composite pattern 300 is a sacrificial target layer 419, which is shown in FIG. 4e. The sacrificial target layer 419 includes structures that can be used by an OPC system in its correction computations but are visible only in the intermediate exposures of the patterns making up the intended pattern and are not visible in the intended pattern. An example is structure 420.

The composite pattern 400 also includes a block mask auxiliary layer 424, which is shown in FIG. 4f. The block mask auxiliary layer 424 is a layer that can have a change impact on the block mask by adding or closing openings and can be used to protect structures that are part of the block mask layer 409. The block mask auxiliary layer 424 includes structure 425, which connects structure 410 with structure 411 (of FIG. 4c) and closes an opening between the structures. Other mask layers can also have auxiliary layers.

Closer examination of the phase mask layer 404 shows that each pair of structures in the phase mask layer 404 (e.g., pairings of structure 405 and structure 406) is separated by a virtual structure, which will later become structures 415 upon subsequent exposure of the block mask layer 409. However, due to the configuration of the block mask layer 409, one of the structures will disappear once the block mask layer 409 is exposed. This structure is shown in FIGS. 4a and 4e as structure 420. Although the structure 420 does not appear in the composite pattern 400 (or the final reproduced pattern on the semiconductor substrate), the structure 420 can be used by an OPC engine in its correction computations. According to a preferred embodiment of the present invention, structures such as the structure 420 and other similar structures, referred to as actual sacrificial structures, can be used by an OPC engine in its correction computations, with an actual sacrificial structure being an actual structure of a mask layer.

As discussed here, adjustment structures can include target structures that are visible in the target layer and actual sacrificial structures that are visible only in intermediate exposures of the mask layers. Other types of adjustment structures are also possible, including sub-resolution structures, i.e., two-dimensional structures with at least one dimension that is too small to resolve on the reproduced pattern, and phantom structures that can be arbitrarily placed onto a target layer. The sub-resolution structures and the phantom structures can also be referred to as virtual sacrificial structures.

Although the sub-resolution structures are too small to resolve on the reproduced pattern, they may be present on one or more of the mask layers and can be used by the OPC system to control mask layer structure dimensions. Examples of sub-resolution structures include lines (one of two dimensions is sub-resolution) and dots (both dimensions are sub-resolution). Phantom structures are structures that are not actually present on any of the mask layers. Their presence on the target layer, however, will have an effect on the resulting structures of the mask layers when taken into account the OPC system, resulting in a difference in the output of mask layers. According to a preferred embodiment of the present invention, phantom structures can be a line or a dot or polygon placed on the target layer.

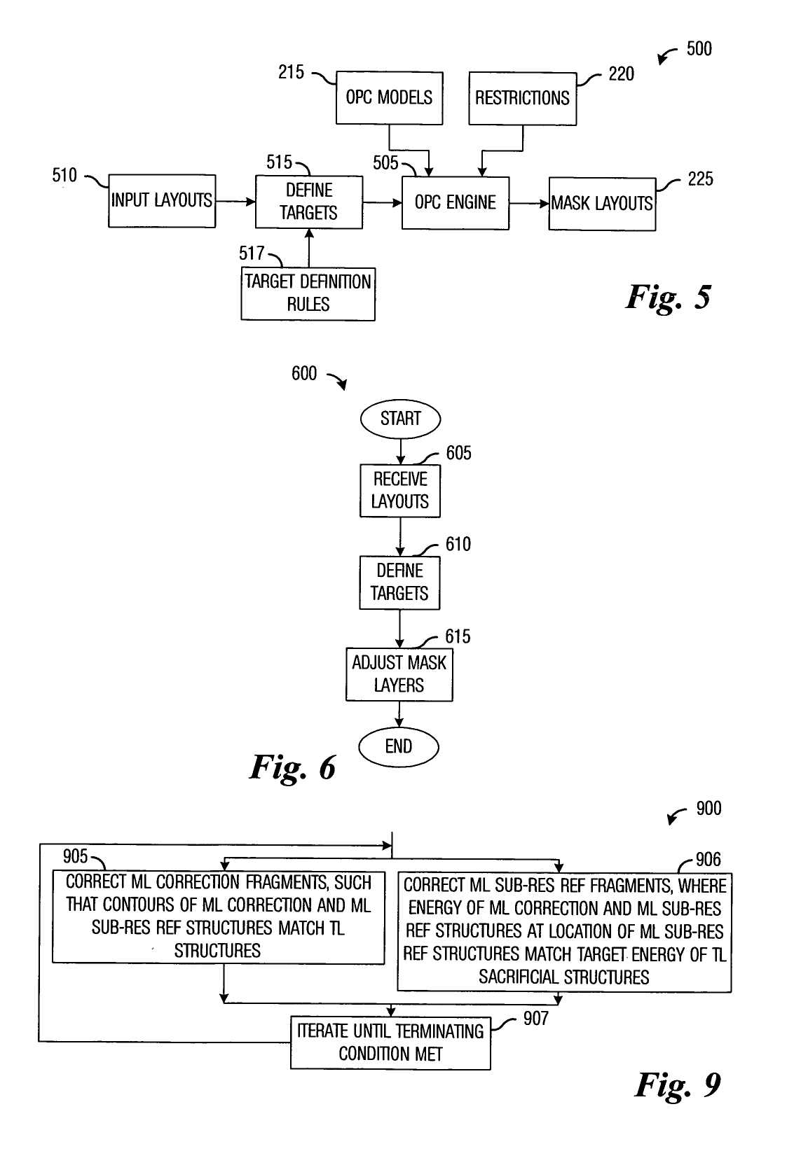

Referring now to FIG. 5, a diagram illustrating an OPC system 500, wherein sacrificial structures are used in the correction computations, is provided according to a preferred embodiment of the present invention. The OPC system 500 includes an OPC engine 505. The OPC engine 505 can take an iterative approach wherein the OPC engine 505 moves a fragment and computes its effect on the reproduced pattern in an attempt to reach a desired result. Alternatively, or in addition, the OPC engine 505 can perform a backwards calculation, wherein the OPC engine 505 computes a change to a fragment based upon the desired result.

Unlike in a prior art OPC engine (e.g., engine 205 of FIG. 2) that just moves a fragment in an attempt to match a simulation of the reproduced pattern to an intended pattern as closely as possible, the OPC engine 505 will move a fragment to match reproduced patterns with the intended pattern, wherein a criteria for moving the fragment can be based on contours from structures in the target layer or an intermediate exposure of a mask layer, and contours generated by sub-resolution structures and phantom structures (the adjustment structures). Furthermore, a criteria for moving fragments utilizing detectable physical parameters such as energy levels rather than contour shapes can also be used by the OPC engine 505 in its correction computations.

The OPC engine 505 can take as input one or more layouts 510 of the intended pattern. For example, utilizing the composite pattern 400 shown in FIG. 4a, input to the OPC engine 505 can include target layer 414, sacrificial target layer 419, mask layers phase mask layer 404, block mask layer 409, and block mask auxiliary layer 424. Other possible layers that can be input into the OPC engine 505 can include correction layers (which contain structures that are corrected by the OPC engine 505), reference layers (which can contain structures similar to sub-resolution structures but are used only in simulation), and auxiliary layers for mask layers other than the block mask layer.

The layouts 510 can then be processed to define targets 515. The definition of targets 515 can utilize rules and algorithms to define usable targets 517. As examples, an algorithm can be used to find edges of structures on a mask layer that will not end up as a target structure and rules can be used to define virtual thresholds and values for use with adjustment structures that affect physical parameters, and so forth. The processing of the layouts 510 to define targets can involve the definition of target dimensions for each sacrificial target with the intent of improving the process window of the resolved layers.

There are at least two different ways that a target can be inputted into an OPC system. A first way would be for the target to be a part of the input layout 510 (such as the target structures of the target layer). A second way would be for the OPC system to compute and/or derive the target from the input layout 510 (such as the sacrificial structures). Utilizing OPC models 215 and restrictions 220, the OPC engine 505 can produce layouts of mask layers 225.

Referring now to FIG. 6, a diagram illustrates a sequence of events 600 in the correction of layer patterns with an OPC system utilizing sacrificial patterns, according to a preferred embodiment of the present invention. The sequence of events 600 can be illustrative of the processing of an intended pattern by the OPC system, for example, an intended pattern comprised of a phase mask layer and a block mask layer, with a target layer representing the intended appearance of the pattern.

The sequence of events 600 can be applicable to other pattern reproduction systems, including single exposure systems and multi-exposure systems. Multi-exposure systems include multiple print (or multiple patterning, multiple masking, and so on) systems that print a first pattern, etch the first pattern, print a second pattern, etch the second pattern, and so forth. The first pattern, the second pattern, and so on make up a single pattern. Multiple orientation polarized light systems use light with different polarities and multiple masks to print structures of a single pattern. Other systems can also be used.

The sequence of events 600 can begin with the OPC system 500 receiving (or retrieving) the layouts 510 of the intended pattern (block 605). There can be individual layouts for the different layers of the pattern. For example, there may be layouts for the phase mask layer, the block mask layer, and the target layer, e.g., as shown in FIG. 4. However, there may also be multiple layouts for each of the layers. For example, the target layer can include layouts for a resolved target layer, a drawn sacrificial target layer (which can include structures that are visible in the target layer), and a non-drawn sacrificial target layer (which comprises sacrificial structures that appear as a result of an intermediate exposure but are not present in the target layer once all exposures are complete). The mask layers (such as the phase mask layer and the block mask layer) can include correction layers as well as reference layers, which in turn can include layers with structures that will reproduce as well as those that will not reproduce and are sacrificial.

Once the OPC system has completed the receiving of the layouts of the intended pattern (block 605), the OPC system can begin processing the various layouts. Included in the processing is the defining of the targets (block 610). The defining of the targets involves defining of the adjustment structures (e.g., target structures and virtual and actual sacrificial targets). As discussed previously, target structures can be structures visible in the target layer, while actual sacrificial target structures can be structures visible in intermediate exposures of the mask layers. Virtual sacrificial target structures can be sub-resolution structures in the mask layer and phantom structures in the target layer. The target structures and sacrificial target structures can be used by the OPC system in its correction computations of the reproduction of the intended pattern onto the semiconductor substrate. The additional information provided by the virtual and actual sacrificial target structures can be used by the OPC system to provide an improved lithographic process window during the reproduction of the intended pattern.

After processing, the input layouts of the various mask layers of the pattern can then be adjusted utilizing OPC models and process restrictions to make the resolved target layers of the reproduced pattern match the intended pattern as best as possible under the constraints of processing time, memory (data size limits), available time, and so forth (block 615). Adjustments include changing fragment position (or not changing fragment position). The adjustments to fragments of phase mask layer(s) and block mask layer(s) can be limited to subsets of all fragments in the mask layers, if such an adjustment is beneficial in reproducing the intended pattern more accurately and/or to account for a better lithographic process window of those intended patterns. This limitation can also be effective in reducing the processing power and time needed to perform the adjustment operation. However, should adequate processing power and/or time be available, the limitation can be relaxed.

According to a preferred embodiment of the present invention, the adjustment to fragments of the input layouts will occur on the various mask layers. For example, in an alternating phase mask dual exposure system, the adjustments will take place in the phase mask layer and the block mask layer. Fragments that can be adjusted independently of one another can be adjusted within a single iteration, while fragments that cannot be adjusted without information arising from the adjustment of other fragments must wait until the needed adjustments have been performed. The adjustments of fragments that can occur independently are referred to as adjustments occurring in parallel, since if multiple processing elements are available, the adjustments can take place simultaneously. The adjustments that must wait for other adjustments to occur are referred to as sequential adjustments.

In addition to simply adjusting fragments of the mask layers, an additional constraint on the proximity of the structures of the mask layers containing the fragment being adjusted to the adjustment structures (e.g., target structures and virtual and actual sacrificial target structures) can be considered. For example, a priority can be given to those fragments of the mask layer structures that abut or are in close proximity to the adjustment structures. These fragments may be the only fragments that are adjusted or these fragments may be adjusted before the fragments that are not in close proximity to the adjustment structures are adjusted. Once again, the relative tightness of the definition of a fragment in close proximity to the adjustment structures can be dependent upon factors such as processing power, memory, available time, layer complexity, and so on.

It may be necessary to repeat the adjustments to the mask layers to ensure that the resulting layout produces a reproduced pattern that matches the intended pattern to within acceptable standards. For example, after a first iteration of adjustments, it may be determined that the reproduced pattern does not meet acceptable standards, then additional iterations of adjustment(s) may need to be performed. Once again, factors such as available design time, processing power, and so forth may limit the number of adjustment operations.

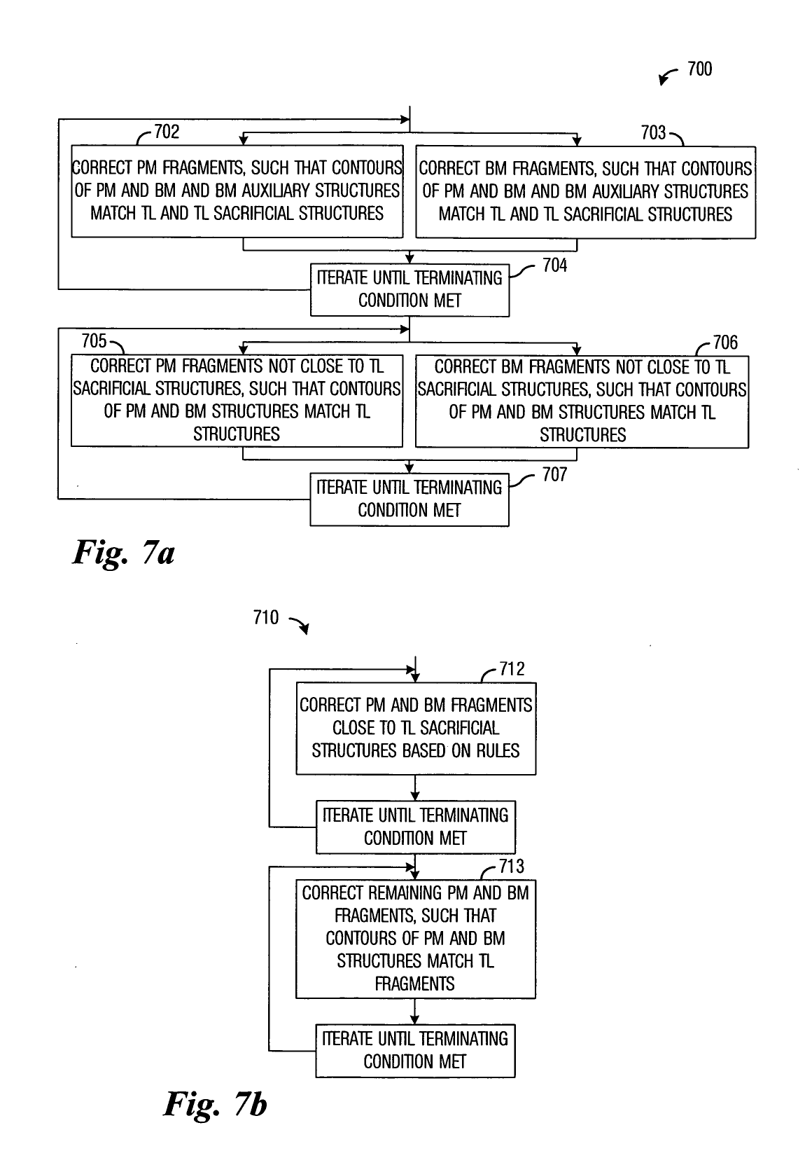

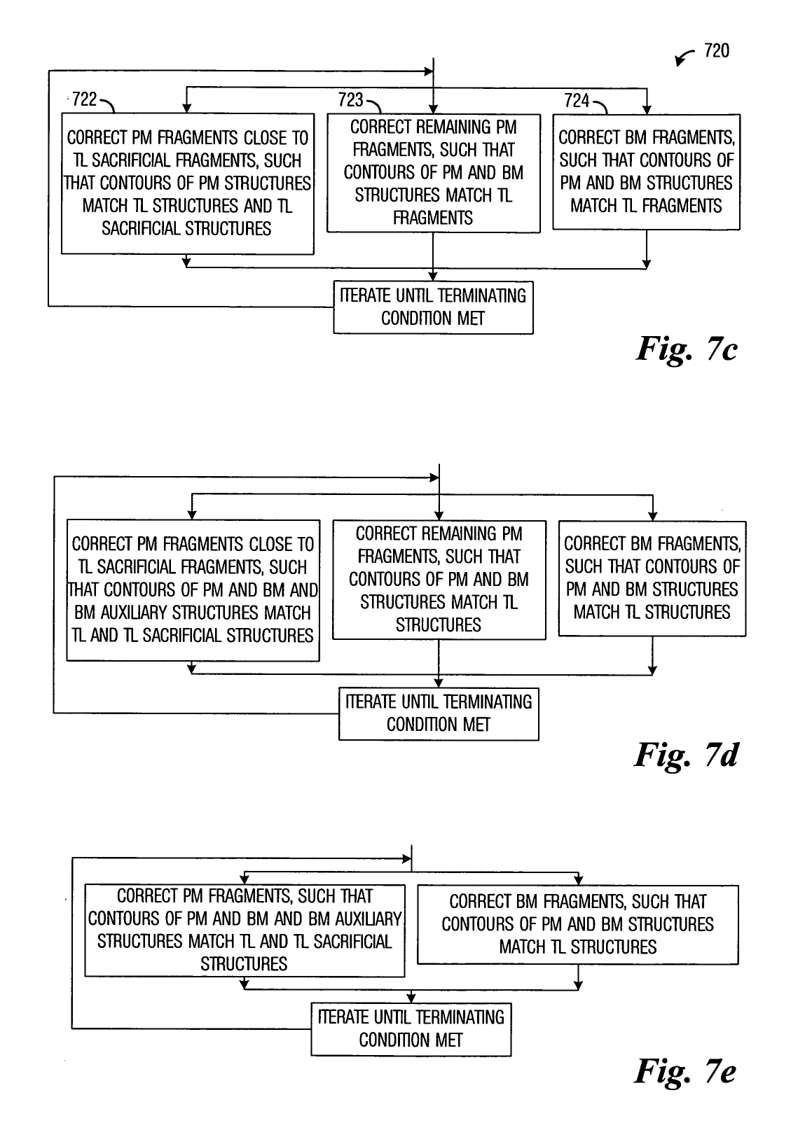

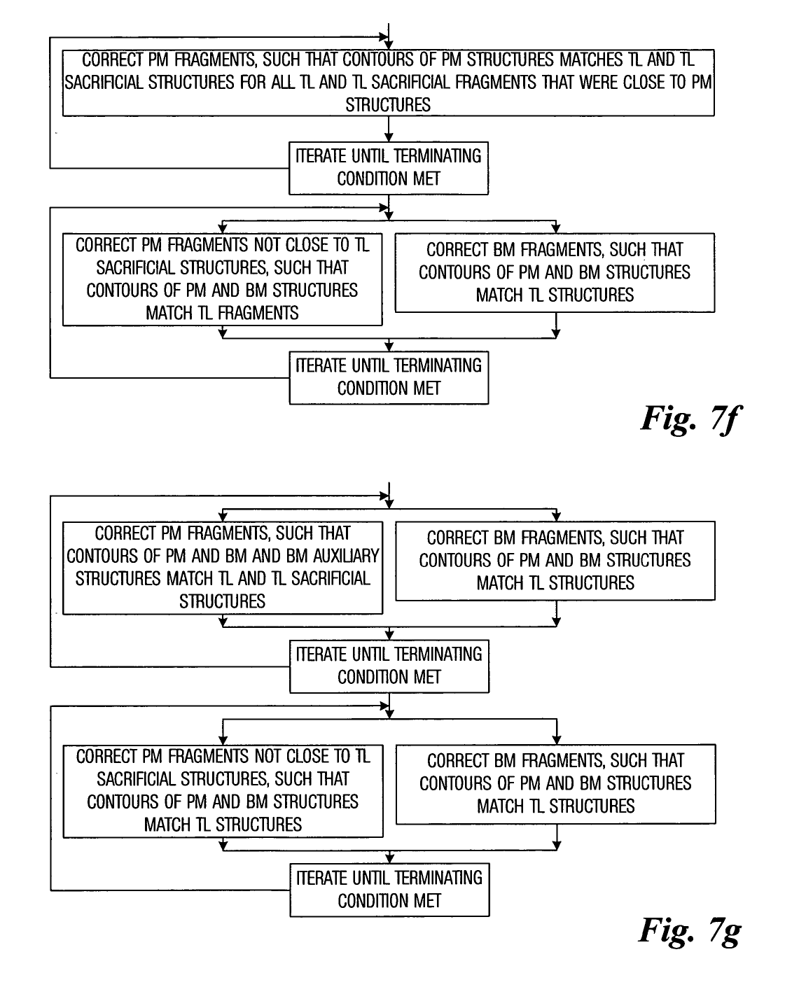

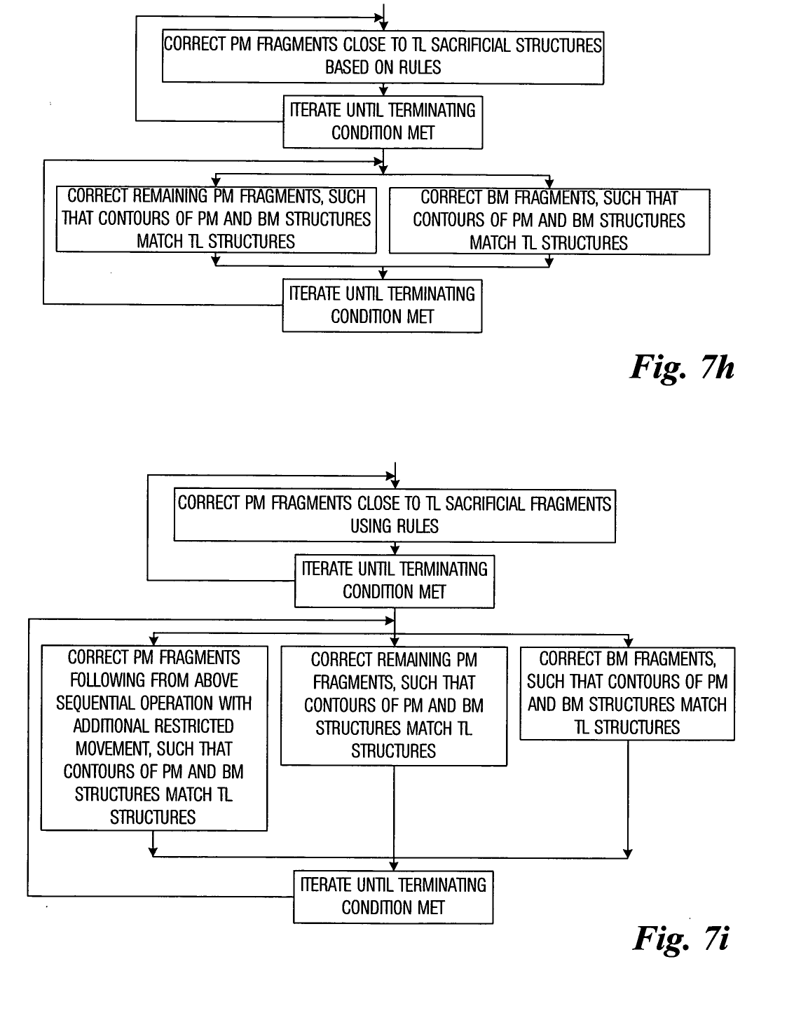

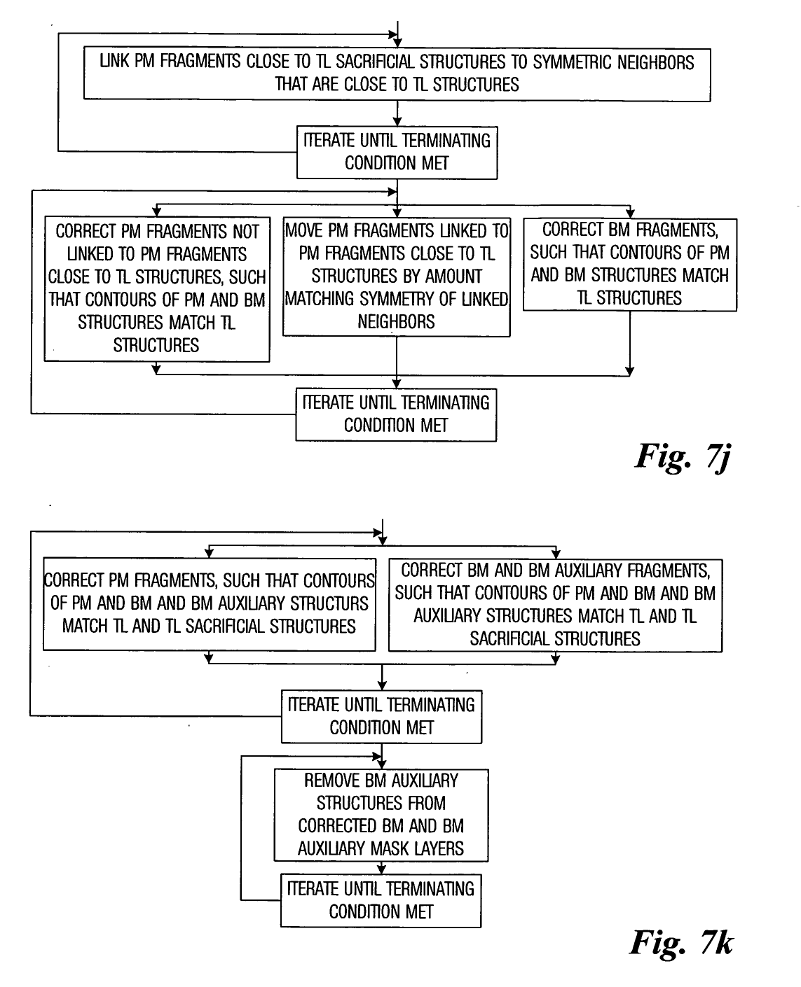

FIGS. 7a through 7k show diagrams illustrating algorithmic representations of exemplary implementations of OPC engines, according to a preferred embodiment of the present invention. The diagrams shown in FIGS. 7a through 7k can be algorithmic representations of implementations of an OPC engine, such as the OPC engine 505 (FIG. 5), in an alternating phase mask dual exposure system. The discussion of implementations of the OPC engine for an alternating phase mask dual exposure system, should not be considered limiting to the scope and spirit of the present invention, which can be applied to other exposure systems, including attenuated branch mask, chrome on glass mask systems, and so forth. The diagrams are not intended to limit the scope and the spirit of the present invention to this single embodiment of a pattern reproduction system.

Some implementations of an OPC engine can include operations that occur in parallel or in series with other operations, while other implementations contain both operations that occur in parallel and in series with other operations. The implementations of the OPC engines illustrated in FIGS. 7a through 7k are for dual exposure systems. The OPC engines can be readily extended to systems utilizing a larger number of exposures by those of ordinary skill in the art of the present invention.

The diagram shown in FIG. 7a illustrates an algorithm 700 that includes operations occurring in parallel and in series. The operations occurring in parallel are responsible for correcting phase mask layer (PM) fragments. Resulting contours of the simulated exposures of the phase mask layer structures and block mask (BM) layer structures, along with block mask auxiliary layer structures, match (or closely match) the target layer (TL) structures and target layer sacrificial structures (block 702) and correcting block mask fragments. Resulting contours of the simulated exposures of the phase mask layer structures and block mask layer structures, along with block mask auxiliary layer structures, match the target layer structures and target layer sacrificial structures (block 703). Correcting a fragment may involve electing to move a fragment and computing an amount of movement. The operations described in block 702 and block 703 can be repeated iteratively until a terminating condition is met (block 704).

After the operations described in block 702 and block 703 complete, two additional operations can execute in parallel. These operations are responsible for correcting phase mask fragments that are not adjacent to nor are close to target layer sacrificial structures. Resulting contours of the simulated exposures of phase mask layer structures and block mask layer structures match the target layer structures (block 705) and correcting block mask layer fragments that are not adjacent to nor are close to target layer sacrificial structures. Resulting contours of the simulated exposures of phase mask layer structures and block mask layer structures match the target layer structures (block 706). A first fragment is not close to a second fragment if the first fragment is greater than a given distance away from the second fragment. The value of the given distance can be set based on desired performance as well as technical factors such as available processing power, memory, time, and so forth. Again, the operations described in block 705 and block 706 can be repeated iteratively until a terminating condition is met (block 707).

The diagram shown in FIG. 7b illustrates an algorithm 710 that includes operations occurring only sequentially. A first operation (block 712) is responsible for correcting and/or moving phase mask layer fragments and block mask layer fragments that are adjacent or close to target layer sacrificial structures based on a set of rules. The rules may specify that a spacing between phase mask layer structures that are adjacent to one another is maintained or that a spacing between block mask layer structures and adjacent phase mask layer structures is maintained. A second operation (block 713) is responsible for correcting remaining phase mask layer fragments and block mask layer fragments (fragments that do not meet the adjacency or closeness criteria of block 712), wherein resulting contours of the simulated exposure of phase mask layer structures and block mask layer structures match the target layer structures.

The diagram shown in FIG. 7c illustrates an algorithm 720 that includes operations occurring only in parallel. A first operation (block 722) is responsible for correcting phase mask layer fragments that are adjacent or close to target layer sacrificial structures. Resulting contours of the simulated exposures of phase mask layer structures match the target layer structures and target layer sacrificial structures. Potentially occurring at the same time is a second operation (block 723), which is responsible for correcting remaining phase mask layer fragments. Resulting contours of the simulated exposures of phase mask layer structures and block mask layer structures match the target layer structures. A third operation (block 724) is responsible for correcting block mask layer fragments, wherein resulting contours of the simulated exposures of phase mask layer structures and block mask layer structures match the target layer structures.

The diagrams shown in FIGS. 7d through 7k illustrate algorithmic representations of implementations of other OPC engines. The diagrams are not intended to display an exhaustive list of possible implementations of OPC engines; rather, the diagrams are intended to display some of the wide range of implementations of OPC engines that can take advantage of sacrificial layer fragments to improve the quality of the reproduced pattern.

A number of adjustment structures have been discussed above. These adjustments structures include target structures present on the target layer, actual sacrificial target structures present on intermediate exposures of the mask layers, and virtual sacrificial target structures that include sub-resolution structures present on the mask layers and phantom structures present on the target layer. These adjustment structures all have an effect on structure fragment location and placement based on their geometric properties, namely their resulting contours when the exposure of their respective mask layers are simulated.

Another form of adjustment structure affects structure fragment location based on their alteration of physical parameters, not geometric properties. For example, an adjustment structure affecting fragment location based on physical parameters can change an energy level seen at the photoresist layer on the semiconductor substrate. Changes affected by these adjustment structures are typically not detectable, but are noticeable via simulation, such as by an OPC system. So, rather than matching a fragment of a structure for adjustment based on geometric properties, such as contour, a fragment can be adjusted based on an adjustment structure's effect on an energy level if the change matches a specified target energy level.

For example, an adjustment structure may not resolve on the photoresist layer, but if the adjustment structure alters an intensity of the light used to pattern the photoresist layer such that it meets a specified threshold, then the adjustment structure can be used to move a fragment of a mask layer structure. The OPC system would detect the change in the intensity of the light on its simulated reproduced pattern, for example, and can make adjustments to the associated fragment in the mask layers. Other examples of physical parameters can include electrical field parameters, image log-slope, and so forth.

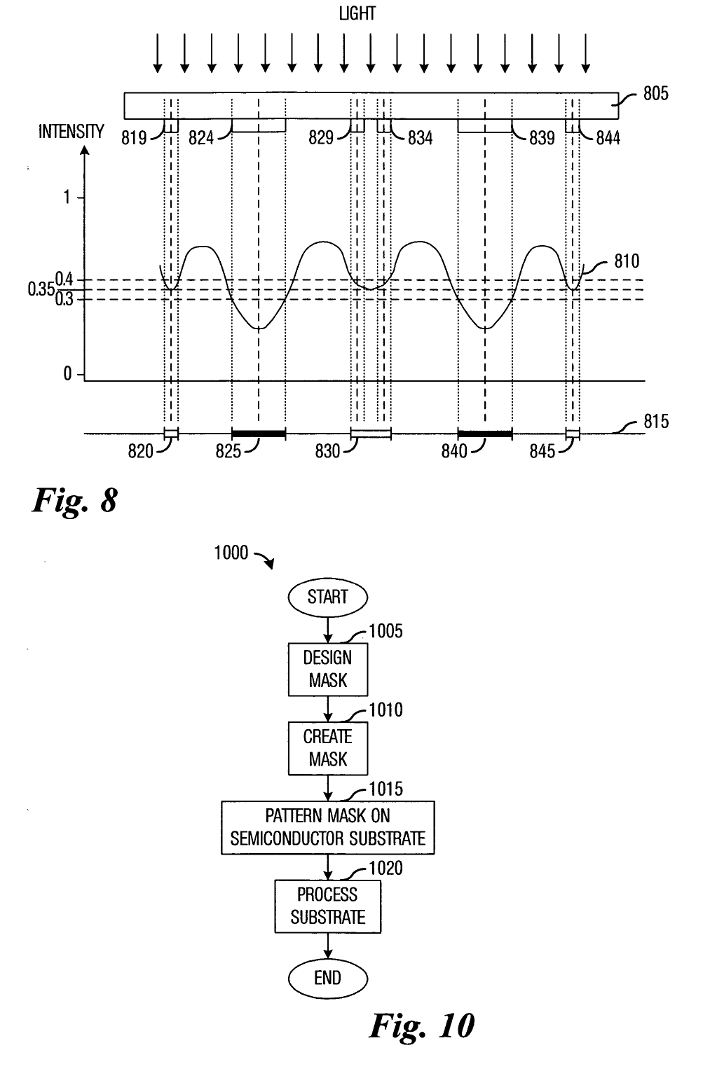

FIG. 8 shows a diagram illustrating mask structures in a photomask and their effect on light passing through the photomask, according to a preferred embodiment of the present invention. The diagram shown in FIG. 8 shows a portion of a binary photomask 805 that is illuminated by a light source (not shown). Structures in the photomask 805 attenuate a light from the light source. An exemplary attenuated light is shown as a waveform 810, with the light intensity as the light strikes a photoresist layer 815. As shown in FIG. 8, if the attenuated light is below a threshold of printability (an exemplary threshold of printability of 0.3 is shown in FIG. 8) when it strikes the surface of the photoresist layer 815, then the portion of the photoresist layer 815 so illuminated is physically changed. If the attenuated light is above the threshold of printability when it strikes the photoresist layer 815, then the portion of the photoresist layer 815 so illuminated is physically unchanged. Although a structure may not attenuate the light to a level adequate for printing, the attenuation may still be detected by the OPC system and the structure can be used to control mask dimensions.

A first structure 819 attenuates the light to a maximum attenuation of 0.35. Since the attenuated light is greater than the threshold of printability, the first structure 819 does not print. However, the OPC system can create a virtual threshold to enable the first structure 819 to virtually print. For example, the OPC system can create a virtual threshold at 0.40 and using the virtual threshold, the first structure 819 can print as a virtual target 820. The virtual threshold can be used to determine a size of the virtual target 820 by computing an intersection of the virtual threshold with the waveform 810. A different value for the virtual threshold can result in a virtual target with a different size. The virtual target 820 can be utilized by the OPC system to make its correction computations, similar to a target that actually prints on the photoresist layer 815.

A second structure 824 attenuates the light to a level below the threshold of printability and therefore creates a target structure 825. Rather than specifying a virtual threshold, the OPC system can specify a virtual value that can be used to specify a desired minima (or maxima). The OPC system can then compute a light attenuation amount (or in general, the effect on a given physical parameter by a structure) for a given structure and then adjust the structure's dimensions so that the light attenuation amount is substantially equal to the virtual value. For example, if the light attenuation amount for a structure is greater than the virtual value, then the OPC system can reduce the size of the structure, while if the light attenuation amount is less than the virtual value, then the OPC system can increase the size of the structure.

For example, with the OPC system specifying a virtual value of 0.35, a third structure 829 and a fourth structure 834 create a single virtual target 830. The third structure 829 and the fourth structure 834 create the single virtual target 830 because the separation between the third structure 829 and the fourth structure 834 is not sufficiently large to actually resolve two distinct virtual targets on the photoresist layer 815. If a separation between the third structure 829 and a fourth structure 834 were greater than a resolution limit, then two virtual sacrificial targets would print. A fifth structure 839 creates a target structure 840 and a sixth structure 844 creates a virtual target 845 (with the virtual threshold set at 0.40).

FIG. 9 shows a diagram illustrating an algorithmic representation 900 of an exemplary implementation of an OPC engine, according to a preferred embodiment of the present invention. The algorithm 900 represents an implementation of an OPC engine, such as the OPC engine 505 (FIG. 5), which makes use of adjustment structures in single exposure masks to enhance correction output. Although the discussion of the algorithm 900 focuses on a single exposure mask system, the algorithm 900 can be readily extended to multiple exposure systems by those of ordinary skill in the art of the present invention.

The algorithm 900 makes use of adjustment structures that have an effect on structure fragment location and placement based on its effect on energy levels that are noticeable via an OPC system in addition to adjustment structures that affect structure fragment location and placement based on their resulting geometric properties. The algorithm 900 includes two operations occurring in parallel.

A first operation (block 905) is responsible for correcting mask layer correction fragments wherein resulting contours of the simulation of the mask layer correction structures and mask layer sub-resolution reference structures match target layer structures. A second operation (block 906) is responsible for correcting mask layer sub-resolution reference fragments where the energy of mask layer correction structures and mask layer sub-resolution reference structures at the location of mask layer sub-resolution reference structures or nearby match target energy of target layer sacrificial targets, such as virtual target 820 (FIG. 8). The operations in block 905 and block 906 can be repeated iteratively until a terminating condition is met (block 907). The one-dimensional adjustment structures can be used in applications such as single exposure binary or attenuated phase shift masks, where the masks contain critical structures and sub-resolution assist features (virtual sacrificial target structures).

FIG. 10 shows a diagram illustrating a sequence of events 1000 in the manufacture of an exemplary semiconductor device, wherein the manufacture utilizes a mask designed using an OPC system, according to a preferred embodiment of the present invention.

The manufacture of the semiconductor device can begin with the design of a mask(s) (block 1005). The design of the mask can include the use of computer design tools that will take a description of the semiconductor device (in a function description, a physical description, or a combination of both descriptions of the semiconductor device) to create a layout of the semiconductor device. The layout of the semiconductor device can then be used to design the mask. The computer design tools can make use of optical proximity correction to make adjustments to structures of the mask to as closely match a computer generated version of the mask with the layout of the semiconductor device. The adjustments of the structures of the mask can be based on the use of targets, including visible targets in the layout and targets that affect geometric properties as well as targets that affect physical parameters.

After the mask has been designed, the mask can be created (block 1010). The created mask can then be used to create a reproduction of the pattern on a resist layer on an upper surface of a semiconductor substrate (block 1015), wherein the created mask can be reproduced onto the resist layer by light or some form of radiation. After patterning, the semiconductor substrate can be processed, such as by etching, to affect the pattern onto the semiconductor substrate (block 1020).

In accordance with another preferred embodiment of the present invention, a method for controlling lithographic mask layer structure dimensions for use in reproducing a pattern is provided. The method includes defining targets based on definition rules and adjusting mask layer structures based on the targets. The targets include targets that affect geometric properties and targets that affect physical properties.

In accordance with another preferred embodiment of the present invention, an optical proximity correction system for use in reproducing a pattern is provided. The system includes a target definition unit coupled to a pattern input and a processing engine. The target definition unit selects target structures in a target layer that is visible in a reproduction of the pattern provided by the pattern input. The target structures also include one or more of the following: actual sacrificial structures that are visible only in an intermediate exposure of the reproduced pattern, virtual sacrificial structures of a mask layer having at least one dimension smaller than a minimum dimension required for resolution, and virtual sacrificial structures not part of the reproduced pattern. The processing engine makes adjustments to mask layer structures based on the selected target structures and fabrication models.

In accordance with another preferred embodiment of the present invention, a method for making a semiconductor device is provided. The method includes designing a mask used to create a pattern by adjusting structures in the mask based on targets and making the designed mask. The method also includes providing a semiconductor wafer having a resist layer formed thereon and irradiating the resist layer through the designed mask to expose an upper surface of the wafer. The method further includes performing a process to affect the upper surface of the wafer. The targets include targets that are visible in the pattern and targets that affect geometric properties.

An advantage of a preferred embodiment of the present invention is that information already present in the different mask layers and target layers can be utilized to help improve the quality of the reproduced pattern. Therefore, additional work need not be performed by the designers to achieve improved results.

Another advantage of a preferred embodiment of the present invention is that the added precision afforded by the use of the additional targets results in a better quality design that is more robust in the face of changing process parameters. The effects of process window OPC can then be achieved without having to perform simulations for the large number of process models, therefore, reducing design time and cost.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for controlling lithographic mask layer structure dimensions for use in reproducing a pattern, the method comprising:
defining targets based on definition rules, wherein the targets comprise targets that are visible in a reproduced pattern and targets that affect geometric properties; and
adjusting mask layer structures based on the targets.

2. The method of claim 1, wherein targets that affect geometric properties comprise target sacrificial structures that are selected from one or more of the following groups: actual sacrificial structures that are visible only in an intermediate exposure of the reproduced pattern, virtual sacrificial structures of a mask layer having at least one dimension smaller than a minimum dimension required for resolution, and virtual sacrificial structures not part of the reproduced pattern.

3. The method of claim 2, wherein a mask layer structure comprises at least one fragment, and wherein the adjusting comprises moving the fragment.

4. The method of claim 2, wherein a multi-exposure system is used to expose masks onto one or more layers of resist, wherein there are multiple mask layers, wherein the targets reside in a mask layer or a layer representing the reproduced pattern, and wherein the adjusting comprises adjusting fragments of a mask layer structure that abuts or is close to a target, such that simulated contours of the mask layer structure closely matches the target.

5. The method of claim 2, wherein the adjusting produces an improved process window for the reproducing of the pattern.

6. A method for controlling lithographic mask layer structure dimensions for use in reproducing a pattern, the method comprising:
defining targets based on definition rules, wherein the targets comprise targets that affect geometric properties and targets that affect physical parameters; and
adjusting mask layer structures based on the targets.

7. The method of claim 6, wherein the targets that affect physical parameters affect an energy level, an electric field, or an image log-slope in a portion of a reproduced pattern, and wherein the adjusting comprises:
setting an artificial threshold based on a desired physical parameter;
calculating a virtual contour for each target affecting the desired physical parameter that meets the artificial threshold; and
adjusting fragments of mask layer structures based on the virtual contour.

8. The method of claim 7, wherein the desired physical parameter is light intensity, and wherein the calculating comprises computing a virtual contour of a target with an associated structure that affects the light intensity to an amount that exceeds the artificial threshold.

9. The method of claim 7, wherein the desired physical parameter is light intensity, and wherein the calculating comprises modifying dimensions of an associated structure of a target so that the affected light intensity due to the structure is strictly less than or equal to the artificial threshold.

10. The method of claim 7, wherein targets that affect physical parameters are created by mask layer sub-resolution reference structures, and wherein the adjusting comprises:
adjusting fragments of mask layer structures such that simulated contours of mask layer structures and of mask layer sub-resolution reference structures closely match the targets; and
adjusting fragments of mask layer sub-resolution reference structures, wherein a physical parameter affected by mask layer correction structures and of mask layer sub-resolution reference structures in close proximity to the mask layer sub-resolution reference structures substantially match a desired value.

11. An optical proximity correction system for use in reproducing a pattern, the system comprising:
a target definition unit coupled to a pattern input, the target definition unit configured to select target structures in a target layer that are visible in reproduction of the pattern provided by the pattern input and target sacrificial structures from one or more of the following groups: actual sacrificial structures that are visible only in an intermediate exposure of the reproduced pattern, virtual sacrificial structures of a mask layer having at least one dimension smaller than a minimum dimension required for resolution, and virtual sacrificial structures not part of the reproduced pattern; and
a processing engine coupled to the target definition unit, the processing engine configured to make adjustments to mask layer structures based on the selected target structures and fabrication models.

12. The system of claim 11, wherein the target definition unit further selects structures based on a change in a physical parameter, and wherein the physical parameter is selected from a group comprising: a light intensity, an electric field, or an image log-slope in a portion of a reproduced pattern.

13. A method of making a semiconductor device, the method comprising:
designing a mask used to create a pattern by adjusting structures in the mask based on targets, wherein the targets comprise targets that are visible in the pattern and targets that affect geometric properties;
making the designed mask;
providing a semiconductor wafer having a resist layer formed thereon;
irradiating the resist layer through the designed mask to expose an upper surface of the wafer; and
performing a process to affect the upper surface of the wafer.

14. The method of claim 13, wherein the semiconductor device includes multiple layers, and wherein the designing, making, providing, irradiating, and performing is repeated for each a multiple layers.

15. The method of claim 14, wherein a layer is irradiated using two masks, and wherein the mask comprises alternating phase shift masks.

16. The method of claim 14, wherein the process comprises an etch process.

17. The method of claim 14, wherein the targets further comprise targets that affect physical parameters.

18. The method of claim 13, wherein targets that affect geometric properties comprise target sacrificial structures that are selected from one or more of the following groups: actual sacrificial structures that are visible only in an intermediate exposure of the reproduced pattern, virtual sacrificial structures of a mask layer having at least one dimension smaller than a minimum dimension required for resolution, and virtual sacrificial structures not part of the reproduced pattern.

19. The method of claim 18, wherein a mask layer structure comprises at least one fragment, and wherein the adjusting comprises moving the fragment.

20. The method of claim 18, wherein a multi-exposure system is used to expose masks onto one or more layers of resist, wherein there are multiple mask layers, wherein the targets reside in a mask layer or a layer representing the reproduced pattern, and wherein the adjusting comprises adjusting fragments of a mask layer structure that abuts or is close to a target, such that simulated contours of the mask layer structure closely matches the target.

21. The method of claim 20, wherein there are two mask layers, and wherein the adjusting comprises:
adjusting fragments of a first mask layer structures such that simulated contours of the first mask layer structures and of second mask layer structures with the second mask auxiliary layer structures closely match target structures and target sacrificial structures;
adjusting fragments of the second mask layer structures such that simulated contours of the first mask layer structures and of the second mask layer structures with the second mask auxiliary layer structures closely match target structures and target sacrificial structures;
after the adjusting of fragments of the first mask layer structures and the second mask layer structures,
adjusting fragments of the first mask layer structures that are not in close proximity to target sacrificial structures such that simulated contours of the first mask layer structures and of the second mask layer structures closely match target structures; and
adjusting fragments of the second mask layer structures that are not in close proximity to target sacrificial structures such that simulated contours of the first mask layer structures and of the second mask layer structures closely match target structures.

22. The method of claim 20, wherein there are two mask layers, and wherein the adjusting comprises:
adjusting fragments of a first mask layer structures and fragments of a second mask layer structures that are in close proximity to target sacrificial structures, wherein the adjusting is subject to restrictions; and
adjusting fragments of remaining first mask layer structures and fragments of remaining second mask layer structures such that simulated contours of first mask layer structures and of second mask layer structures closely match the target structures.

23. The method of claim 22, wherein the restrictions comprise one or more of the following: maintaining a spacing between fragments of adjusted first mask layer structures that project onto each other, maintaining a spacing between fragments of adjusted first mask layer structures that abut target sacrificial structures, and maintaining a spacing between adjusted second mask layer structures and adjacent first mask layer structures.

24. The method of claim 14, wherein the adjusting produces an improved process window for the reproducing of the pattern.
